(19) United States
(12) Patent Application Publication
(10) Pub. No.: US 2025/0393059 A1
(43) Pub. Date: Dec. 25, 2025

(54) CHANNEL SELECTION FOR OFF-CHANNEL P2P COMMUNICATION

(71) Applicant: Samsung Electronics Co., Ltd., Suwon-si (KR)

(72) Inventors: Rubayet Shafin, Frisco, TX (US); Boon Loong Ng, Plano, TX (US); Peshal Nayak, Plano, TX (US); Vishnu Vardhan Ratnam, Frisco, TX (US); Yue Qi, Plano, TX (US)

(21) Appl. No.: 19/224,331

(22) Filed: May 30, 2025

Related U.S. Application Data
(60) Provisional application No. 63/662,817, filed on Jun. 21, 2024.
(60) Provisional application No. 63/663,538, filed on Jun. 24, 2024.

(51) Int. Cl. H04W 72/27; H04W 72/40; H04W 84/12

(52) U.S. Cl. CPC H04W 72/27; H04W 72/40; H04W 84/12

(57) ABSTRACT

Methods and apparatuses for a channel selection for off-channel peer-to-peer (P2P) communication. A method performed by a first access point (AP) includes negotiating with a second AP for selecting a channel for off-channel peer-to-peer (P2P) communication among non-AP stations (STAs). The channel for off-channel P2P communication comprises a channel that the first AP, the second AP, or both the first AP and the second AP do not intend to use for operating a respective first basic service set (BSS) or a second BSS.

### CROSS-REFERENCE TO RELATED APPLICATION(S) AND CLAIM OF PRIORITY

This application claims priority under 35 U.S.C. § 119 (e) to U.S. Provisional Patent Application No. 63/662,817, filed on Jun. 21, 2024, and U.S. Provisional Patent Application No. 63/663,538, filed on Jun. 24, 2024, which are hereby incorporated by reference in their entirety.

### TECHNICAL FIELD

This disclosure relates generally to wireless communication, and more specifically to a channel selection procedure for off-channel peer-to-peer (P2P) communication.

### BACKGROUND

Wireless Local Area Network (WLAN) technology allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

Embodiments of the present disclosure provide methods and apparatuses for channel selection for off-channel P2P communication.

In one embodiment, a method of wireless communication performed by a first access point (AP) comprises negotiating with a second AP for selecting a channel for off-channel P2P communication among non-AP stations (STAs). The channel for off-channel P2P communication comprises a channel that the first AP, the second AP, or both the first AP and the second AP do not intend to use for operating a respective first basic service set (BSS) or a second BSS.

In another embodiment, a first AP comprises a transceiver and a processor operably coupled with the transceiver. The processor is configured to negotiate with a second AP for selecting a channel for off-channel P2P communication among STAs. The channel for off-channel P2P communication comprises a channel that the first AP, the second AP, or both the first AP and the second AP do not intend to use for operating a respective first BSS or a second BSS.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit”, “receive”, and “communicate”, as well as derivatives thereof, encompass both direct and indirect communication. The terms “include” and “comprise”, as well as derivatives thereof, mean inclusion without limitation. The term “or” is inclusive, meaning and/or. The phrase “associated with”, as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example AP according to embodiments of the present disclosure;

FIG. 3 illustrates an example station (STA) according to embodiments of the present disclosure;

FIG. 4 illustrates an example of a network where infrastructure traffic and non-infrastructure traffic coexist according to embodiments of the present disclosure;

FIG. 5 illustrates an example of P2P STAs switching between an APs channel and an off channel according to embodiments of the present disclosure;

FIG. 6 illustrates an example of a network architecture coexisting with P2P groups according to embodiments of the present disclosure;

FIG. 7 illustrates an example of coordinated off-channel P2P (C-OCP) architecture for unmanaged networks according to embodiments of the present disclosure;

FIG. 8 illustrates an example of a transaction for C-OCP negotiation according to embodiments of the present disclosure;

FIG. 9 illustrates an example of a frame exchange for C-OCP announcement according to embodiments of the present disclosure;

FIG. 10 illustrates an example of a type-II architecture for C-OCP managed networks according to embodiments of the present disclosure;

FIG. 11 illustrates an example of a C-OCP negotiation for managed network type-II according to embodiments of the present disclosure;

FIG. 12 illustrates an example of a frame exchange for P2P channel selection according to embodiments of the present disclosure;

FIG. 13 illustrates an example of an exchange of channel usage request/response frame for OCP according to embodiments of the present disclosure;

FIG. 14 illustrates an example of a confirmation phase after the P2P channel negotiation according to embodiments of the present disclosure;

FIG. 15 illustrates an example of timing information sharing for availability for P2P operation for a given channel according to embodiments of the present disclosure;

FIG. 16 illustrates an example of an announcement of a set of time windows in a set of channels conducive for P2P communication according to embodiments of the present disclosure; and

FIG. 17 illustrates an example method performed by an AP according to embodiments of the present disclosure.

### DETAILED DESCRIPTION

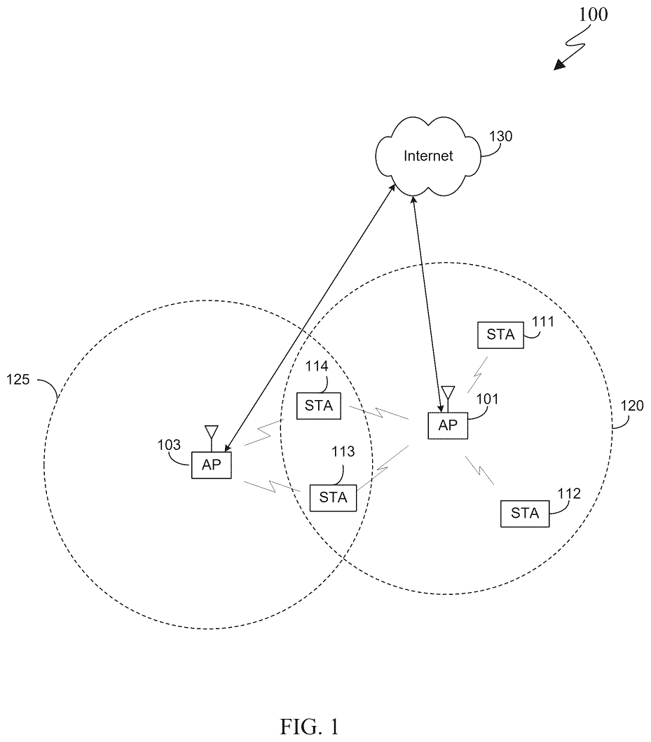

FIGS. 1 through 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] IEEE P802.11be—D3.0″Part 11: Wireless LAN Medium Access Control (MAC) and Physical Layer (PHY) Specifications—Amendment 8: Enhancements for extremely high throughput (EHT) “; [2] IEEE P802.11REVme —D2.1″Part 11: Wireless LAN Medium Access Control (MAC) and Physical Layer (PHY) Specifications”.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WI-FI or other WLAN communication techniques. The STAs 111-114 may communicate with each other using peer-to-peer protocols, such as Tunneled Direct Link Setup (TDLS).

Depending on the network type, other well-known terms may be used instead of “access point” or “AP”, such as “router” or “gateway”. For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA”, such as “mobile station”, “subscriber station”, “remote terminal”, “user equipment”, “wireless terminal”, or “user device”. For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the APs may include circuitry and/or programming for facilitating a channel selection for off-channel P2P communication. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

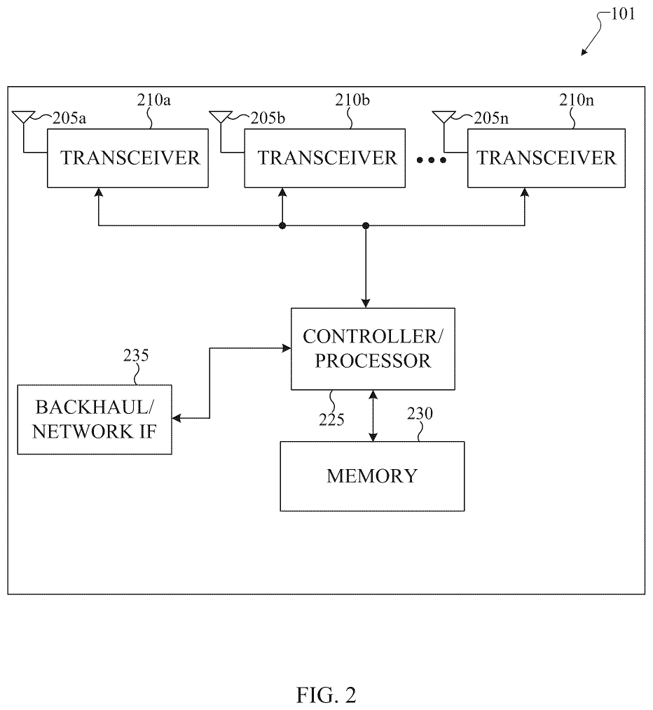

FIG. 2 illustrates an example AP 101 according to various embodiments of the present disclosure. The embodiment of the AP 101 illustrated in FIG. 2 is for illustration only, and the AP 103 of FIG. 1 could have the same or similar configuration. However, APs come in a wide variety of configurations, and FIG. 2 does not limit the scope of this disclosure to any particular implementation of an AP.

The AP 101 includes multiple antennas 205a-205n and multiple transceivers 210a-210n. The AP 101 also includes a controller/processor 225, a memory 230, and a backhaul or network interface 235. The transceivers 210a-210n receive, from the antennas 205a-205n, incoming radio frequency (RF) signals, such as signals transmitted by STAs 111-114 in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the AP 101. For example, the controller/processor 225 could control the reception of forward channel signals and the transmission of reverse channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing signals from multiple antennas 205a-205n are weighted differently to effectively steer the outgoing signals in a desired direction. The controller/processor 225 could also support OFDMA operations in which outgoing signals are assigned to different subsets of subcarriers for different recipients (e.g., different STAs 111-114). Any of a wide variety of other functions could be supported in the AP 101 by the controller/processor 225 including facilitating a channel selection for off-channel P2P communication. In some embodiments, the controller/processor 225 includes at least one microprocessor or microcontroller. The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the AP 101 to communicate with other devices or systems over a backhaul connection or over a network. The interface 235 could support communications over any suitable wired or wireless connection(s). For example, the interface 235 could allow the AP 101 to communicate over a wired or wireless local area network or over a wired or wireless connection to a larger network (such as the Internet). The interface 235 includes any suitable structure supporting communications over a wired or wireless connection, such as an Ethernet or RF transceiver. The memory 230 is coupled to the controller/processor 225. Part of the memory 230 could include a RAM, and another part of the memory 230 could include a Flash memory or other ROM.

As described in more detail below, the AP 101 may include circuitry and/or programming for facilitating a channel selection for off-channel P2P communication. Although FIG. 2 illustrates one example of AP 101, various changes may be made to FIG. 2. For example, the AP 101 could include any number of each component shown in FIG. 2. As a particular example, an access point could include a number of interfaces 235, and the controller/processor 225 could support routing functions to route data between different network addresses. Alternatively, only one antenna and transceiver path may be included, such as in legacy APs. Also, various components in FIG. 2 could be combined, further subdivided, or omitted and additional components could be added according to particular needs.

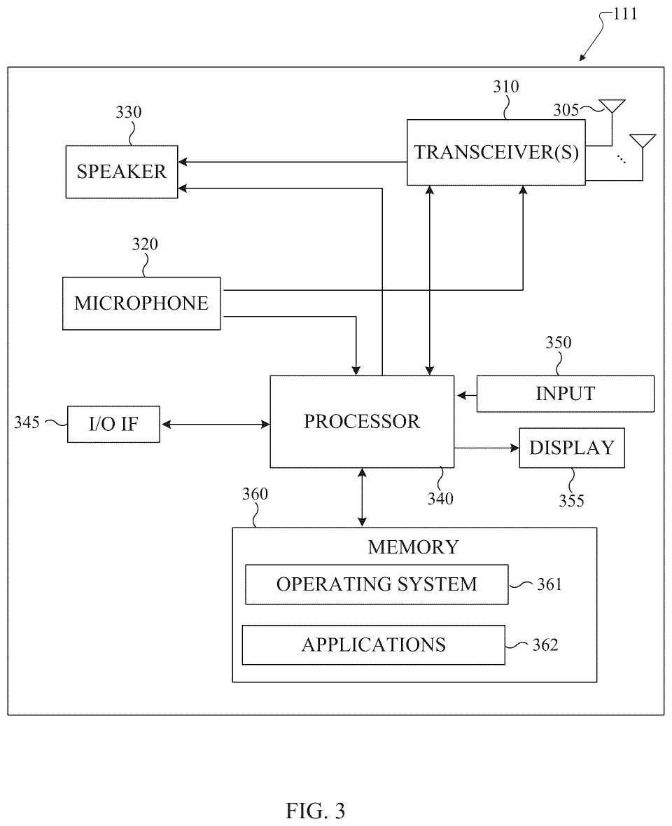

FIG. 3 illustrates an example STA 111 according to various embodiments of the present disclosure. The embodiment of the STA 111 illustrated in FIG. 3 is for illustration only, and the STAs 111-114 of FIG. 1 could have the same or similar configuration. However, STAs come in a wide variety of configurations, and FIG. 3 does not limit the scope of this disclosure to any particular implementation of a STA.

The STA 111 includes antenna(s) 305, transceiver(s) 310, a microphone 320, a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna(s) 305, an incoming RF signal (e.g., transmitted by an AP 101 of the network 100). The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors and execute the basic OS program 361 stored in the memory 360 in order to control the overall operation of the STA 111.

In one such operation, the processor 340 controls the reception of forward channel signals and the transmission of reverse channel signals by the transceiver(s) 310 in accordance with well-known principles. The processor 340 can also include processing circuitry configured to facilitate a channel selection for off-channel P2P communication. In some embodiments, the processor 340 includes at least one microprocessor or microcontroller.

The processor 340 is also capable of executing other processes and programs resident in the memory 360, such as operations for facilitating a channel selection for off-channel P2P communication. The processor 340 can move data into or out of the memory 360 as required by an executing process. In some embodiments, the processor 340 is configured to execute a plurality of applications 362, such as applications for facilitating a channel selection for off-channel P2P communication. The processor 340 can operate the plurality of applications 362 based on the OS program 361 or in response to a signal received from an AP. The processor 340 is also coupled to the I/O interface 345, which provides STA 111 with the ability to connect to other devices such as laptop computers and handheld computers. The I/O interface 345 is the communication path between these accessories and the processor 340.

The processor 340 is also coupled to the input 350, which includes for example, a touchscreen, keypad, etc., and the display 355. The operator of the STA 111 can use the input 350 to enter data into the STA 111. The display 355 may be a liquid crystal display, light emitting diode display, or other display capable of rendering text and/or at least limited graphics, such as from web sites. The memory 360 is coupled to the processor 340. Part of the memory 360 could include a random-access memory (RAM), and another part of the memory 360 could include a Flash memory or other read-only memory (ROM).

Although FIG. 3 illustrates one example of STA 111, various changes may be made to FIG. 3. For example, various components in FIG. 3 could be combined, further subdivided, or omitted and additional components could be added according to particular needs. In particular examples, the STA 111 may include any number of antenna(s) 305 for MIMO communication with an AP 101. In another example, the STA 111 may not include voice communication or the processor 340 could be divided into multiple processors, such as one or more central processing units (CPUs) and one or more graphics processing units (GPUs). Also, while FIG. 3 illustrates the STA 111 configured as a mobile telephone or smartphone, STAs could be configured to operate as other types of mobile or stationary devices.

Embodiments of the present disclosure recognize that a next generation WLAN system needs to provide better support for low-latency applications. Today it is not uncommon to observe numerous devices operating on the same network. Many of such devices may be latency-tolerant but still contend with the devices with low-latency applications for the same time and frequency resources. In some cases, the access point (AP) as the network controller may not have enough control over the unregulated/unmanaged traffic that contend with the low-latency traffic within the infrastructure BSS. Some of the unmanaged traffic that interfere with the AP's BSS' latency sensitive traffic may be coming from uplink (UL)/downlink (DL) or direct link communications within the infrastructure BSS that the AP manages; others may be due to transmission in the neighboring infrastructure BSS (OBSS); yet others may be coming from neighboring independent BSS or P2P networks. The next generation WLAN system needs mechanisms to better handle the unmanaged traffic in order to prioritize the low-latency traffic in the network.

Embodiments of the present disclosure recognize that in the IEEE 802.11be specification, the SCS procedure was enhanced, and a new element, the QoS characteristics element, was introduced, which can be included in the SCS Request and SCS Response frames. The non-AP STA can send to the AP the SCS with the QoS Characteristics element, where the non-AP STA indicates its traffic flow characteristics. The AP can review the SCS request received from the non-AP STA and, upon acceptance, provisions resources to the non-AP STA based on the traffic characteristics described in the QoS Characteristics element included in the SCS request.

Embodiments of the present disclosure recognize that a P2P STA often needs to operate on both the AP's channel (base channel) and the off-channel. They switch between these two types of channels. Embodiments of the present disclosure recognize that for P2P group operation, the P2P STAs don't have a mechanism to identify what are the good channels for Off-Channel P2P communication.

Accordingly, embodiments of the present disclosure can provide mechanisms and protocols for efficient P2P operation for off-channel P2P communication.

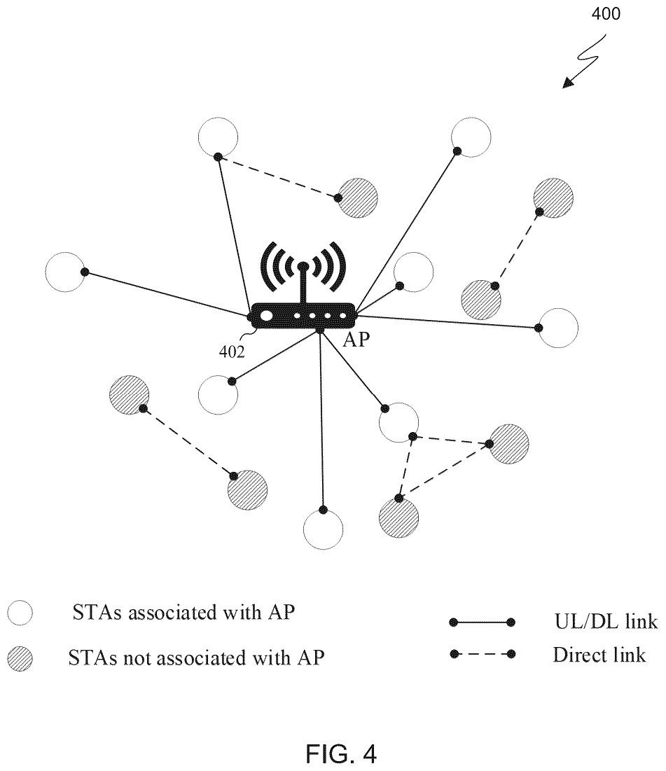

FIG. 4 illustrates an example of a network 400 where infrastructure traffic and non-infrastructure traffic coexist according to embodiments of the present disclosure. For example, the network 400 can be implemented in network 100 of FIG. 1. The embodiment of the example network 400 where infrastructure traffic and non-infrastructure traffic coexist shown in FIG. 4 is for illustration only. Other embodiments of the example network 400 where infrastructure traffic and non-infrastructure traffic coexist could be used without departing from the scope of this disclosure.

As illustrated in FIG. 4, the AP 402 as the network controller may not have enough control over the unregulated/unmanaged traffic that contend with the low-latency traffic within the infrastructure BSS. Some of the unmanaged traffic that interfere with the AP's BSS' latency sensitive traffic may be coming from uplink (UL)/downlink (DL) or direct link communications within the infrastructure BSS that the AP manages; others may be due to transmission in the neighboring infrastructure BSS (OBSS); yet others may be coming from neighboring independent BSS or P2P networks. FIG. 4 illustrates this kind of network.

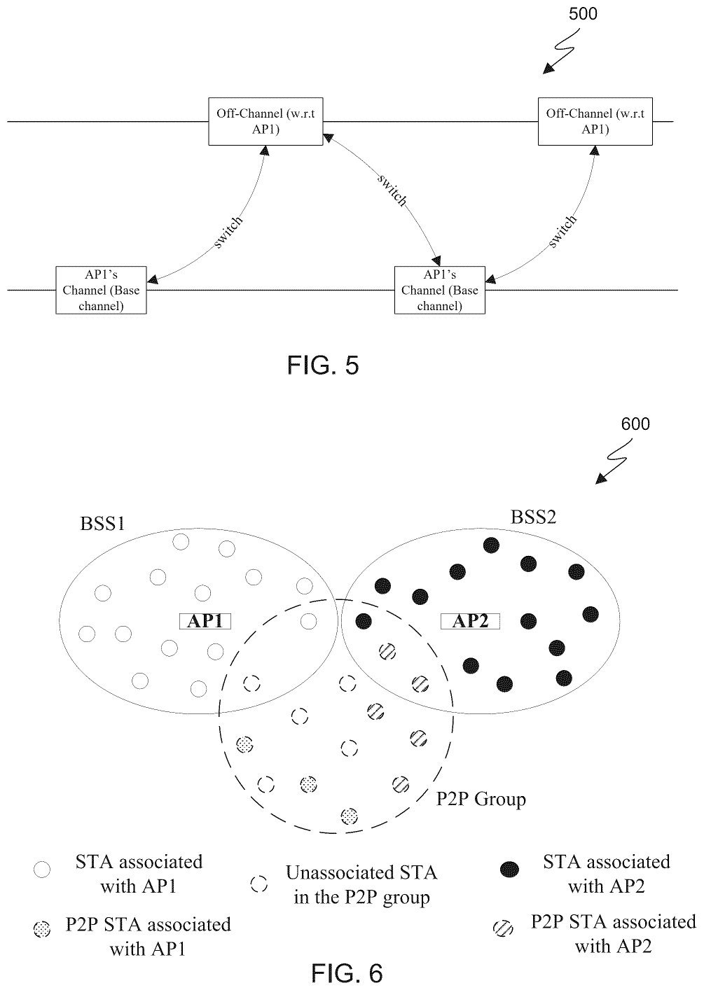

FIG. 5 illustrates an example of P2P STAs switching between an APs channel and an off channel 500 according to embodiments of the present disclosure. For example, the P2P STAs switching between an APs channel and an off channel 500 can be implemented by STAs 111-113, APs 101, 103, and network 100 of FIG. 1. The embodiment of the P2P STAs switching between an APs channel and an off channel 500 shown in FIG. 5 is for illustration only. Other embodiments of the P2P STAs switching between an APs channel and an off channel 500 could be used without departing from the scope of this disclosure.

As illustrated in FIG. 5, a P2P STA often needs to operate on both the AP's channel (base channel) and the off-channel. They switch between these two types of channels. This is illustrated in FIG. 5.

FIG. 6 illustrates an example of a network architecture coexisting with P2P groups 600 according to embodiments of the present disclosure. For example, the network architecture coexisting with P2P groups 600 can be implemented by STAs 111-113, APs 101, 103, and network 100 of FIG. 1. The embodiment of the network architecture coexisting with P2P groups 600 shown in FIG. 6 is for illustration only. Other embodiments of the network architecture coexisting with P2P groups 600 could be used without departing from the scope of this disclosure.

As illustrated in FIG. 6, a typical network architecture is shown where multiple APs operate in the vicinity of each other. At the same time, there operates a P2P group that may overlap with one of more BSSs such as PSS1 and BSS2 as shown in FIG. 6.

According to some embodiments, a first AP can request a second AP to declare a channel that would be conducive for peer-to-peer (P2P) communication among different non-AP STAs. This P2P-conducive channel can be off-channel for either or both of the APs, i.e., either the first AP or the second AP or both APs don't intend to use this channel for operating their respective BSS (the channel used by an AP's operating the BSS can be referred to as the base channel). P2P communication over such an off-channel can be referred to as the off-channel P2P.

According to some embodiments, a first AP can coordinate with a second AP in order to select one or more channels that are conducive to off-channel P2P communication. Such coordination among two or more APs can be referred to as Coordinated Off-Channel P2P (C-OCP) or Coordinated Off-Channel Selection (C-OCS).

According to some embodiments, when a first AP and a second AP participate in C-OCP, as a result of successful coordination/negotiation between the APs—
The first AP can declare a set of channels (say, Set-A that can contain one or more channels) for off-channel P2P communication.
The second AP can declare a set of channels (say, Set-B that can contain one or more channels) for off-channel P2P communication.
Set-A and Set-B can be disjoint sets, i.e., there may not be any channel common to both sets
Set-A and Set-B can be overlapping sets, i.e., there can be one or more channels that are common to both sets
Set-A and Set-B can be equal sets; i.e. all the channels in both sets can be the same.

According to some embodiments, if a first AP declares a channel to be conducive for off-channel P2P, then—
The first AP can reduce the infrastructure operation on that channel
The first AP can refrain from using that channel for infrastructure operation.

According to some embodiments, if a first AP and a second AP successfully negotiate on C-OCP and declare the same or different sets of channels for off-channel P2P, then both the first AP and the second AP can either reduce the infrastructure operation on the respective sets of channels that they declare for off-channel P2P communication. According to another embodiment, the APs can refrain from using the respective sets of channels for their infrastructure operation.

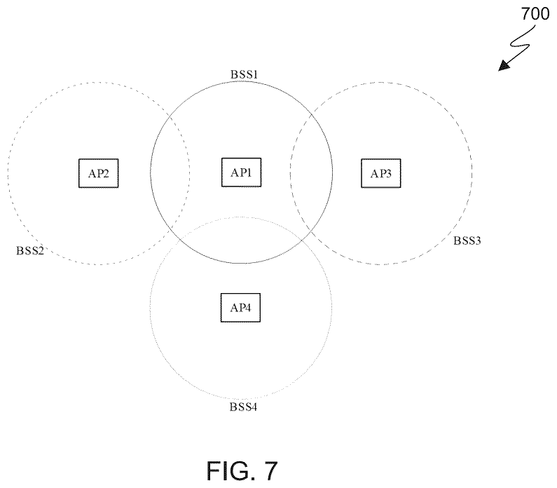

FIG. 7 illustrates an example of C-OCP architecture for unmanaged networks 700 according to embodiments of the present disclosure. The embodiment of the example of C-OCP architecture for unmanaged networks 700 shown in FIG. 7 is for illustration only. Other embodiments of the example of C-OCP architecture for unmanaged networks 700 could be used without departing from the scope of this disclosure.

According to some embodiments, there can be different network architectures for C-OCP. For example, C-OCP can be applied for either managed networks or unmanaged networks. In the unmanaged networks, the APs participating in the C-OCP can operate independently and is not controlled by any central controller. This can also be referred to as a Type-I architecture. Residential environment is an example of such networks. A C-OCP architecture of unmanaged network is shown in FIG. 7.

According to some embodiments, based on Type-I architecture for C-OCP negotiation, a first AP intending to participate in a C-OCP coordination can send a C-OCP Request frame to a second AP in its vicinity in order to request for C-OCP coordination. Transmitting the C-OCP Request frame would initiate the negotiation for the C-OCP. The C-OCP Request frame may contain information such as—
Capabilities of the APs participating in the C-OCP
Time duration of coordination (e.g. in terms of TBTT or other in terms of TSF value)
Multi-AP synchronization related information
Modes of C-OCP coordination
An example format for the C-OCP Request frame is shown in Table-I.

TABLE I
A format of the C-OCP Request frame

| Order | Information |
|---|---|
| 1 | Category |
| 2 | Unprotected S1G Action |
| 3 | Dialog Token |
| 4 | Multi-AP (MAP) C-OCP Coordination Mode |
| 5 | MAP Capabilities Information |

According to some embodiments, the second AP, after receiving the C-OCP Request frame from the first AP can send a C-OCP Response frame to the first AP indicating its response to the received C-OCP request. If the second AP indicates acceptance of the C-OCP request, then the first AP and the second AP enter into the C-OCP phase. An example format of the C-OCP Response frame is shown in Table-II.

TABLE II
A format of the C-OCP Response frame

| Order | Information |
|---|---|
| 1 | Category |
| 2 | Unprotected S1G Action |
| 3 | Dialog Token |
| 4 | MAP C-OCP Coordination Mode |
| 5 | MAP Capabilities Information |

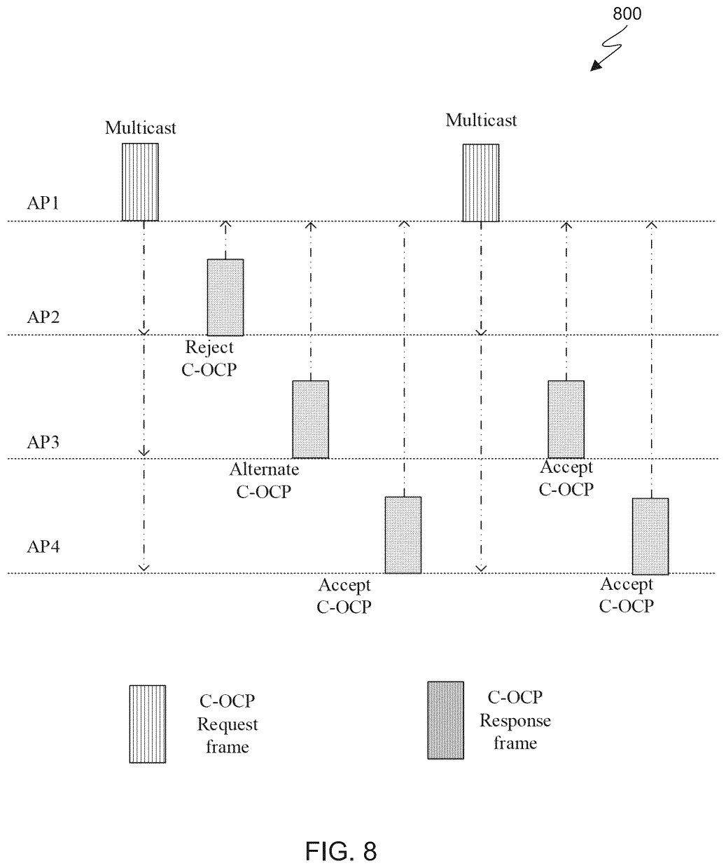

An illustration of the frame exchanges based on this embodiment of Type-I architecture is shown in FIG. 8.

FIG. 8 illustrates an example of a transaction for C-OCP negotiation 800 according to embodiments of the present disclosure. The embodiment of the example of a transaction for C-OCP negotiation 800 shown in FIG. 8 is for illustration only. Other embodiments of the example of a transaction for C-OCP negotiation 800 could be used without departing from the scope of this disclosure.

As illustrated in FIG. 8, AP1 intends to participate in a C-OCP coordination and can send a C-OCP request frame to AP2, AP3, and AP4 in order to request C-OCP coordination. AP2, after receiving the C-OCP request frame from AP1, can send a C-OCP response frame to the AP1 indicating its response to the received C-OCP request. Similarly, AP3 and AP4 can send a C-OCP response frames to AP1 indicating their responses to the received C-OCP request.

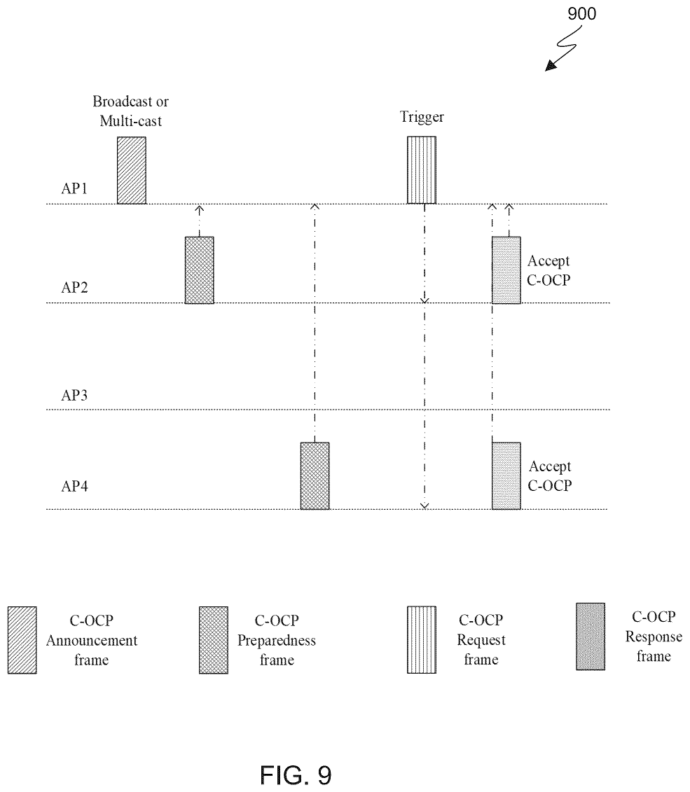

FIG. 9 illustrates an example of a frame exchange for C-OCP announcement 900 according to embodiments of the present disclosure. The embodiment of the example of a frame exchange for C-OCP announcement 900 shown in FIG. 9 is for illustration only. Other embodiments of the example of a frame exchange for C-OCP announcement 900 could be used without departing from the scope of this disclosure.

According to some embodiments, for Type-I architecture for C-OCP negotiation, an announcement phase may precede active negotiation between the APs. According to this embodiment, a first AP that intends to initiate C-OCP multiple AP coordination with other APs may first transmit a C-OCP announcement frame to identify the APs in its neighborhood that are willing to participate in C-OCP MAP coordination. Upon receiving the C-OCP announcement frame from the first AP, the second AP may send a C-OCP Preparedness frame to the first AP indicating its capability to participate in the C-OCP MAP coordination. In the C-OCP preparedness frame, AP2 can also indicate the modes of coordination it supports in its BSS. An illustration of an example negotiation mechanism for C-OCP coordination where the C-OCP negotiation phase is preceded by a C-OCP announcement frame by the AP is shown in FIG. 8.

According to one embodiment, an example of the C-OCP announcement frame is shown in Table III.

TABLE III
A format of the C-OCP Announcement frame

| Order | Information |
|---|---|
| 1 | Category |
| 2 | C-OCP Coordination Mode |
| 3 | MAP Capabilities Information |

An example format of the C-OCP Preparedness frame is shown in Table IV.

TABLE IV
A format of the C-OCP Preparedness frame

| Order | Information |
|---|---|
| 1 | Category |
| 2 | Unprotected S1G Action |
| 3 | C-OCP Coordination Mode |
| 4 | MAP Capabilities Information |

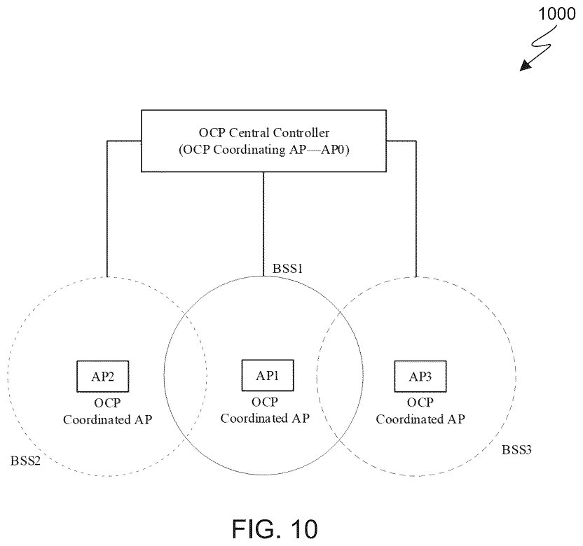

FIG. 10 illustrates an example of a type-II architecture for C-OCP managed networks 1000 according to embodiments of the present disclosure. The embodiment of the example of a type-II architecture for C-OCP managed networks 1000 shown in FIG. 10 is for illustration only. Other embodiments of the example of a type-II architecture for C-OCP managed networks 1000 could be used without departing from the scope of this disclosure.

According to some embodiments, in Type-II architecture of coordinated C-OCP negotiation, the APs' (for example C-OCP scheduling APs)C-OCP negotiations are controlled by a C-OCP central controller. Any kind of C-OCP multi-AP negotiation are done through the central controller. A Type-II architecture for coordinated C-OCP negotiation is illustrated in FIG. 9.

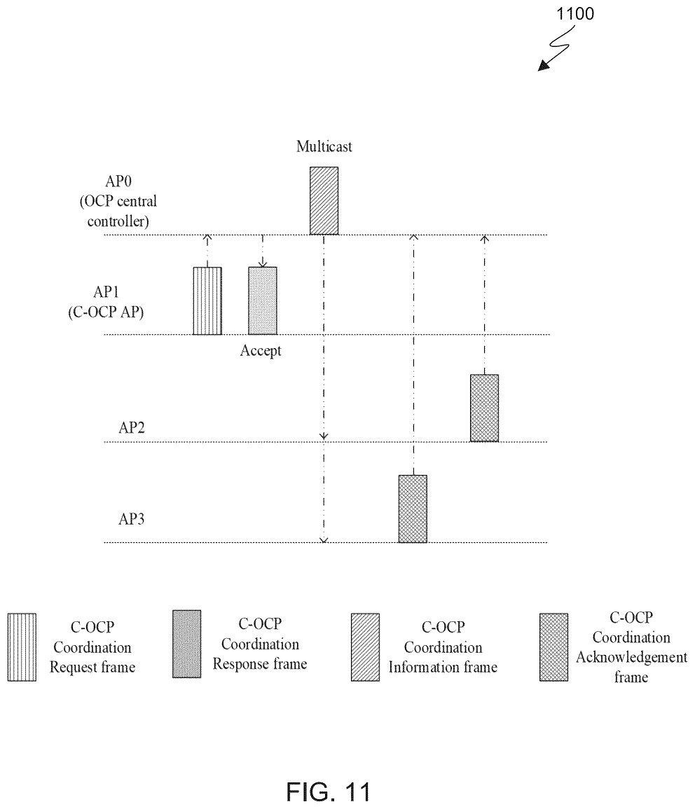

FIG. 11 illustrates an example of a C-OCP negotiation for managed network type-II 1100 according to embodiments of the present disclosure. The embodiment of the example of a C-OCP negotiation for managed network type-II 1000 shown in FIG. 11 is for illustration only. Other embodiments of the example of a C-OCP negotiation for managed network type-II 1100 could be used without departing from the scope of this disclosure.

According to some embodiments, in Type-II architecture for C-OCP negotiation, a first AP that intends to initiate the multi-AP coordination with other APs can first send a C-OCP coordination request frame to the C-OCP central controller. The C-OCP central controller may have C-OCP schedules of all APs that are connected with the controller. Upon receiving the C-OCP coordination request frame from the first AP, the central controller can send a response frame to the first AP based on the overall network situation. If the central controller accepts the coordination request, then the central controller can send a C-OCP coordination information frame to other APs (as the controller finds suitable for coordination) triggering the APs to participate in the C-OCP coordination initiated by the first AP. Subsequently, the APs that receive a C-OCP coordination information frame from the central controller can send a C-OCP coordination acknowledgement frame to the central controller as an acknowledgment for the reception. This process is illustrated in FIG. 11 using a timing diagram.

Embodiments of the present disclosure recognize that currently, there is no mechanism where a non-AP STA can send a message to the APs requesting the APs to open up one or more channels for P2P operation. However, such a procedure would be useful for efficient off-channel P2P communication. In addition, embodiments of the present disclosure recognize that an indication of timing information when announcing channels for P2P is also missing in the current IEEE specification.

Accordingly, embodiments of the present disclosure can provide mechanisms and protocols for efficient P2P operation for off-channel P2P communication. Further, embodiments of the present disclosure can provide mechanisms to share timing information among APs and between APs and non-AP STAs for off-channel P2P communication.

According to some embodiments, a non-AP STA can send a message to its associated AP requesting the AP to declare some channels for peer-to-peer (P2P) communication. Such channels can be conducive to peer-to-peer communication compared to any other channels. These channels can be off-channel with respect to the AP's operation in its BSS. Communication between the P2P STAs on such channels can be referred to as off-channel P2P (OCP).

According to some embodiments, in the message that the non-AP STA sends to the associated AP requesting the associated AP to declare one or more channels for off-channel P2P operation, the non-AP STA may include the following—
The link ID, when the non-AP MLD has established multiple links with the AP MLD, of the link or band of channel in which the non-AP MLD requests the AP MLD to declare one or more channel as the off-channel P2P channels.
The traffic requirement of the non-AP STA that sends the request to the AP for P2P communication between that non-AP STA and other non-AP STAs.
The traffic requirement of a P2P group where the non-AP STA that sends the request to the AP is a member of the P2P group. The STAs within the P2P group intend to use the channel that the AP dedicates for P2P communication for a portion of the traffic delivery within the P2P group.
Information on the time cadence of traffic or traffic arrival pattern of the traffic that the non-AP STA intends the off-channel P2P channel for.
Information on characteristics of the other peer STAs of the non-AP STA sending the request to the AP. Such information can be whether the peer STA is associated with the same AP or not; or whether in the same ESS or not; traffic priority of the peer STA of the non-AP STA, etc.
Information on the characteristics of the P2P group where the non-AP STA belongs to.

According to some embodiments, if an AP receives a message from a non-AP STA, where the message indicates that the non-AP STA requests the AP to dedicate some channels for P2P communication, the AP can dedicate one or more channels for P2P communication.

According to some embodiments, for the scenario where an AP dedicates/declares one or more channels for P2P communication, the AP may either not use those channels for its own infrastructure operation or reduce infrastructure operation on those channels.

According to some embodiments, for the scenario where an AP dedicates/declares one or more channels for P2P communication, the AP may announce this information (that identifies such channels as the off-channel P2P channels) in its BSS. For this purpose, the AP may contain this information in the Beacon frame or Probe Response frame or Association Response frame or Reassociation Response frame.

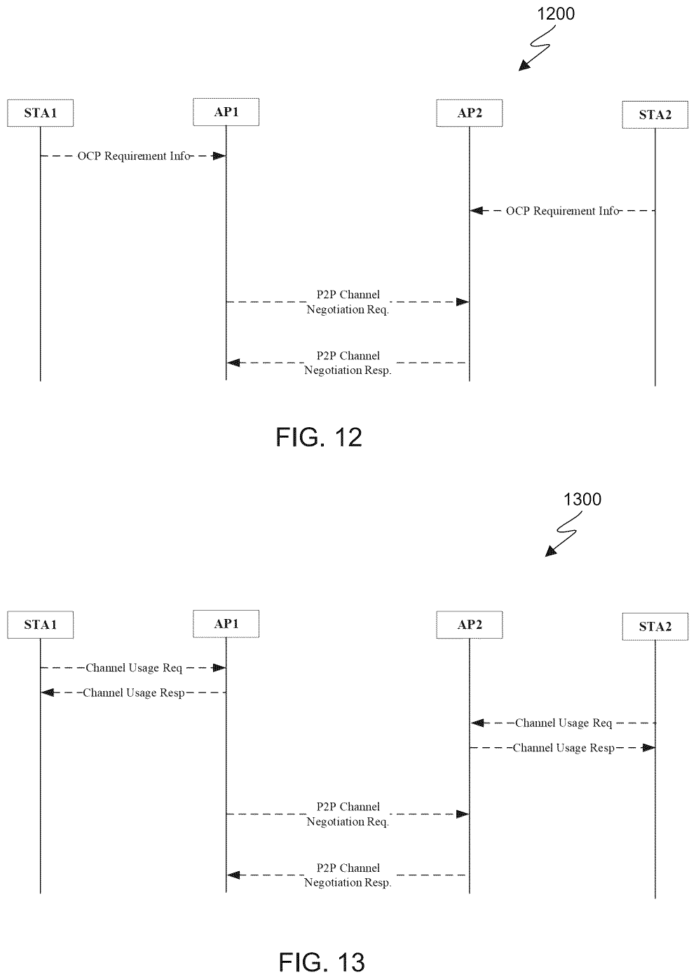

FIG. 12 illustrates an example of a frame exchange for P2P channel selection 1200 according to embodiments of the present disclosure. The embodiment of the example of a frame exchange for P2P channel selection 1200 shown in FIG. 12 is for illustration only. Other embodiments of the example of a frame exchange for P2P channel selection 1200 could be used without departing from the scope of this disclosure.

According to some embodiments, a first STA can send a message to its associated first AP that includes information on the requirement of the first STA with regard to its off-channel P2P communications. Such a frame can be referred to as OCP Requirement Info frame. Alternatively, such information can be carried in an element called OCP Requirement Info element that can be carried in a frame. A second STA can also send such information to its associated second AP. Based on the information received from the first STA and the second STA by the first AP and the second AP, respectively, the first AP and the second AP can exchange information or negotiate to determine a common channel that would be suitable for the P2P communication. This is illustrated in FIG. 12.

FIG. 13 illustrates an example of an exchange of channel usage request/response frame for OCP 1300 according to embodiments of the present disclosure. The embodiment of the example of an exchange of channel usage request/response frame for OCP 1300 shown in FIG. 13 is for illustration only. Other embodiments of the example of an exchange of channel usage request/response frame for OCP 1300 could be used without departing from the scope of this disclosure.

In reference to some embodiments, in order to negotiate on a set of channels for P2P communication, a first AP can send a P2P channel negotiation request frame to the second AP. Upon receiving the P2P channel negotiation request frame from the first AP, the second AP can send a P2P channel negotiation response frame to the first AP. The response frame may indicate whether the second AP agrees to the set of channels suggested by the first AP. If the second AP agrees, then the second AP can indicate ACCEPT in the response. Otherwise, the second AP can indicate REJECT in the response or can indicate an alternative set of channels in the response. The above embodiments are illustrated in FIG. 12.

According to some embodiments, instead of OCP requirement info exchange, the STA can also send a channel usage request frame to its associated AP. In response, the AP can send a channel usage response frame to the STA. This is illustrated in FIG. 13.

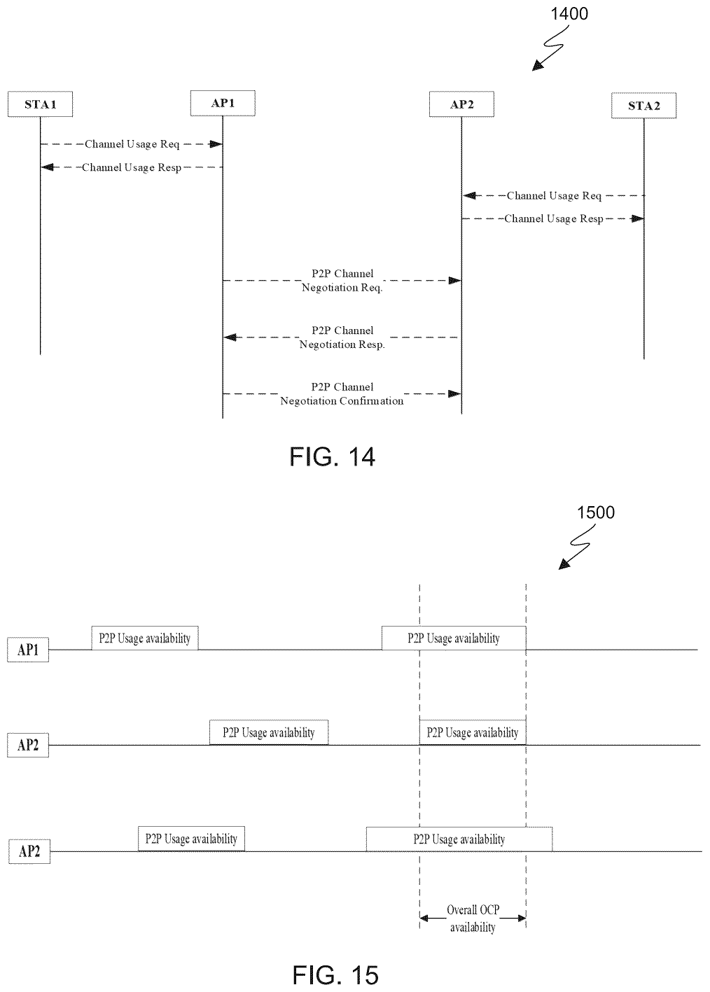

FIG. 14 illustrates an example of a confirmation phase after the P2P channel negotiation 1400 according to embodiments of the present disclosure. The embodiment of the example of a confirmation phase after the P2P channel negotiation 1400 shown in FIG. 14 is for illustration only. Other embodiments of the example of a confirmation phase after the P2P channel negotiation 1400 could be used without departing from the scope of this disclosure.

According to some embodiments, after the exchange of P2P channel negotiation request/response, a P2P channel negotiation confirmation frame can also be sent by either the first AP or the second AP to confirm the final set of channels or other parameters for off-channel P2P channel selection. This is illustrated in FIG. 14.

According to some embodiments, in reference to the previous embodiments, the first AP in the P2P Channel Negotiation Request frame may indicate a first set of channels that the first AP can declare to be conducive for P2P communication. The second AP can also indicate a second set of channel channels it deems to be conducive for P2P communication. If there is an overlap between the first set of channels and the second set of channels, then the common channels can be deemed to be conducive for the P2P communication from both the first AP's BSS and the second AP's BSS. Both the first AP and the second AP can announce this common channels in their respective BSS.

FIG. 15 illustrates an example of timing information sharing for availability for P2P operation for a given channel 1500 according to embodiments of the present disclosure. The embodiment of the example of timing information sharing for availability for P2P operation for a given channel 1500 shown in FIG. 15 is for illustration only. Other embodiments of the example of timing information sharing for availability for P2P operation for a given channel 1500 could be used without departing from the scope of this disclosure.

According to some embodiments, in reference to previous embodiments described herein, the first AP in the P2P channel negotiation request frame may indicate a first set of channels along with a time duration information corresponding to each channels during which it would the first AP would reduce the infra-operation in those channels. In other words, during the indicated time windows for a first indicated channel, it would be conducive for P2P communication. In the response frame the second AP can also indicate a set of time windows for a set of channels during which it would minimize infra operation in those channels. This is illustrated in FIG. 14.

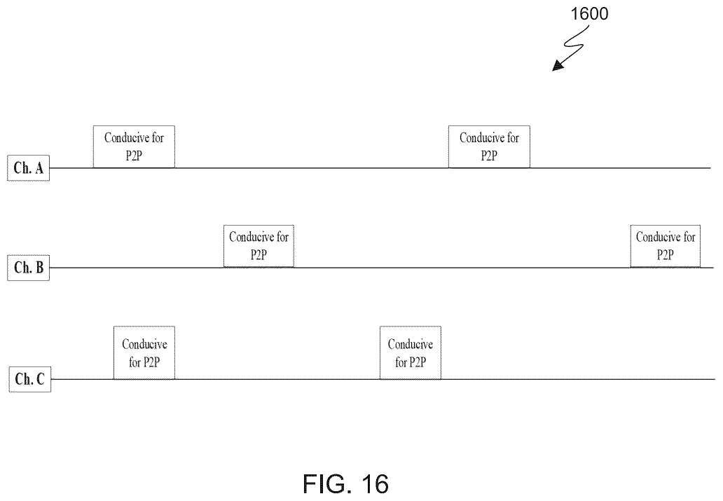

FIG. 16 illustrates an example of an announcement of a set of time windows in a set of channels conducive for P2P communication 1600 according to embodiments of the present disclosure. The embodiment of the example of an announcement of a set of time windows in a set of channels conducive for P2P communication 1600 shown in FIG. 16 is for illustration only. Other embodiments of the example of an announcement of a set of time windows in a set of channels conducive for P2P communication 1600 could be used without departing from the scope of this disclosure.

According to some embodiments, based on the information shared among the MAP OCP negotiation participating APs, the APs in their respective BSS may announce a set of time windows for each channel in a set of channels. These sets of time windows can be regarded as more conducive for P2P communication rather than using any random time windows in any random channel. This is illustrated in FIG. 16.

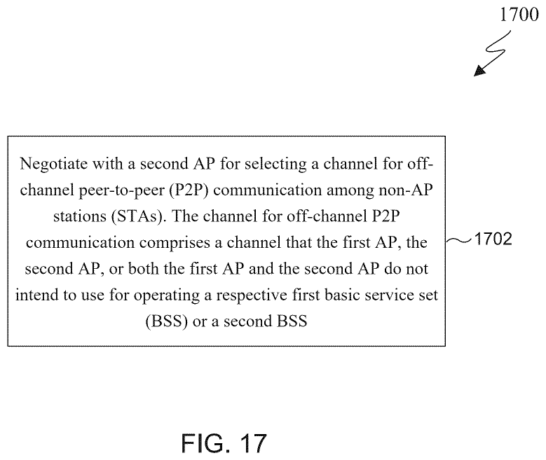

FIG. 17 illustrates an example method 1700 performed by a first AP in a wireless communication system according to embodiments of the present disclosure. For example, the method 1700 of FIG. 17 can be performed by any of the APs 101-103 of FIG. 1, such as AP 101 of FIG. 2. The method 1700 is for illustration only and other embodiments can be used without departing from the scope of the present disclosure.

As illustrated in FIG. 17, the method 1700 begins at step 1702, where the first AP negotiates with a second AP for selecting a channel for off-channel peer-to-peer (P2P) communication among non-AP stations (STAs). The channel for off-channel P2P communication comprises a channel that the first AP, the second AP, or both the first AP and the second AP do not intend to use for operating a respective first basic service set (BSS) or a second BSS.

In some embodiments, negotiating for selecting the channel is successful, and the first AP is further configured to declare a set of channels for off-channel P2P communication, the set of channels comprising one or more channels.

In some embodiments, the first AP is further configured to: reduce infrastructure operation on the set of channels; or refrain from using the set of channels for infrastructure operation.

In some embodiments, the first AP is further configured to: transmit a request message to the second AP to request for coordinating selection of the channel for off-channel P2P communication. The request message includes information associated with at least one of: capabilities of APs participating in the selection of the channel for off-channel P2P communication, a time duration of coordination for coordinating selection of the channel for off-channel P2P communication, multi-AP synchronization for coordinating selection of the channel for off-channel P2P communication, and modes of coordination for coordinating selection of the channel for off-channel P2P communication.

In some embodiments, the first AP is further configured to: receive a response message from the second AP in response to the request message, the response message indicating acceptance or rejection of the request for coordinating selection of the channel for off-channel P2P communication.

In some embodiments, the first AP is further configured to: transmit an announcement message to the second AP to identify APs that are willing to participate in coordinating selection of the channel for off-channel P2P communication; and receive, via the transceiver, a response to the announcement message from the second AP indicating a capability or a non-capability to participate in coordinating selection of the channel for off-channel P2P communication.

In some embodiments, the first AP is further configured to: receive a message from a non-AP station (STA) associated with the first AP, the message requesting the first AP to declare the channel for off-channel P2P communication among the non-AP STAs. The message from the non-AP STA includes information associated with at least one of: a link ID, when the non-AP STA has established multiple links with the first AP, of a link or band of channels in which the non-AP STA requests the first AP to declare the channel for off-channel P2P communication, a traffic requirement of the non-AP STA for P2P communication between the non-AP STA and other non-AP STAs, characteristics of a P2P group that the non-AP STA is a member of, a time cadence of traffic or traffic arrival pattern of traffic that the non-AP STA intends the channel for off-channel P2P channel for, and characteristics of other peer STAs of the non-AP STA.

In some embodiments, the first AP is further configured to: dedicate the channel for off-channel P2P communication among the non-AP STAs; and reduce infrastructure operation on the dedicated channel; or refrain from using the dedicated channel for infrastructure operation.

In some embodiments, the first AP is further configured to: receive, via the transceiver, a message from a non-AP station (STA) associated with the first AP, the message including information on a requirement of the STA regarding off-channel P2P communication of the STA.

In some embodiments, the first AP is further configured to: determine a first set of channels for off-channel P2P communication, the first set of channels comprising one or more channels; determine a time duration, corresponding to each channel of the first set of channels, during which the first AP will reduce infrastructure operation on the first set of channels; and transmit the first set of channels and the time duration to the second AP.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method of wireless communication performed by a first access point (AP), the method comprising:
negotiating with a second AP for selecting a channel for off-channel peer-to-peer (P2P) communication among non-AP stations (STAs),
wherein the channel for off-channel P2P communication comprises a channel that the first AP, the second AP, or both the first AP and the second AP do not intend to use for operating a respective first basic service set (BSS) or a second BSS.

2. The method of claim 1, wherein negotiating for selecting the channel is successful, and the method further comprises:
declaring a set of channels for off-channel P2P communication, the set of channels comprising one or more channels.

3. The method of claim 2, further comprising:
reducing infrastructure operation on the set of channels; or
refraining from using the set of channels for infrastructure operation.

4. The method of claim 1, wherein negotiating with the second AP comprises:
transmitting a request message to the second AP to request for coordinating selection of the channel for off-channel P2P communication,
wherein the request message includes information associated with at least one of:
capabilities of APs participating in the selection of the channel for off-channel P2P communication,
a time duration of coordination for coordinating selection of the channel for off-channel P2P communication,
multi-AP synchronization for coordinating selection of the channel for off-channel P2P communication, and
modes of coordination for coordinating selection of the channel for off-channel P2P communication.

5. The method of claim 4, further comprising:
receiving a response message from the second AP in response to the request message, the response message indicating acceptance or rejection of the request for coordinating selection of the channel for off-channel P2P communication.

6. The method of claim 1, wherein negotiating with the second AP comprises:
transmitting an announcement message to the second AP to identify APs that are willing to participate in coordinating selection of the channel for off-channel P2P communication; and
receiving a response to the announcement message from the second AP indicating a capability or a non-capability to participate in coordinating selection of the channel for off-channel P2P communication.

7. The method of claim 1, further comprising:
receiving a message, from a non-AP station (STA) associated with the first AP, requesting the first AP to declare the channel for off-channel P2P communication among the non-AP STAs,
wherein the message from the non-AP STA includes information associated with at least one of:
a link ID, when the non-AP STA has established multiple links with the first AP, of a link or band of channels in which the non-AP STA requests the first AP to declare the channel for off-channel P2P communication,
a traffic requirement of the non-AP STA for P2P communication between the non-AP STA and other non-AP STAs,
characteristics of a P2P group that the non-AP STA is a member of,
a time cadence of traffic or traffic arrival pattern of traffic that the non-AP STA intends the channel for off-channel P2P channel for, and
characteristics of other peer STAs of the non-AP STA.

8. The method of claim 7, further comprising:
dedicating the channel for off-channel P2P communication among the non-AP STAs; and
reducing infrastructure operation on the dedicated channel; or
refraining from using the dedicated channel for infrastructure operation.

9. The method of claim 1, further comprising:
receiving a message, from a non-AP station (STA) associated with the first AP, that includes information on a requirement of the STA regarding off-channel P2P communication of the STA.

10. The method of claim 1, further comprising:
determining a first set of channels for off-channel P2P communication, the first set of channels comprising one or more channels;
determining a time duration, corresponding to each channel of the first set of channels, during which the first AP will reduce infrastructure operation on the first set of channels; and
transmitting the first set of channels and the time duration to the second AP.

11. A first access point (AP) comprising:
a transceiver; and
a processor operably coupled with the transceiver, the processor configured to negotiate with a second AP for selecting a channel for off-channel peer-to-peer (P2P) communication among non-AP stations (STAs),
wherein the channel for off-channel P2P communication comprises a channel that the first AP, the second AP, or both the first AP and the second AP do not intend to use for operating a respective first basic service set (BSS) or a second BSS.

12. The first AP of claim 11, wherein negotiating for selecting the channel is successful, and the processor is further configured to:
declare a set of channels for off-channel P2P communication, the set of channels comprising one or more channels.

13. The first AP of claim 12, wherein the processor is further configured to:
reduce infrastructure operation on the set of channels; or
refrain from using the set of channels for infrastructure operation.

14. The first AP of claim 11, wherein to negotiate with the second AP, the processor is further configured to:
transmit, via the transceiver, a request message to the second AP to request for coordinating selection of the channel for off-channel P2P communication,
wherein the request message includes information associated with at least one of:
capabilities of APs participating in the selection of the channel for off-channel P2P communication,
a time duration of coordination for coordinating selection of the channel for off-channel P2P communication,
multi-AP synchronization for coordinating selection of the channel for off-channel P2P communication, and
modes of coordination for coordinating selection of the channel for off-channel P2P communication.

15. The first AP of claim 14, wherein the processor is further configured to:
receive, via the transceiver, a response message from the second AP in response to the request message, the response message indicating acceptance or rejection of the request for coordinating selection of the channel for off-channel P2P communication.

16. The first AP of claim 11, wherein to negotiate with the second AP, the processor is further configured to:
transmit, via the transceiver, an announcement message to the second AP to identify APs that are willing to participate in coordinating selection of the channel for off-channel P2P communication; and
receive, via the transceiver, a response to the announcement message from the second AP indicating a capability or a non-capability to participate in coordinating selection of the channel for off-channel P2P communication.

17. The first AP of claim 11, wherein the processor is further configured to:
receive, via the transceiver, a message from a non-AP station (STA) associated with the first AP, the message requesting the first AP to declare the channel for off-channel P2P communication among the non-AP STAs,
wherein the message from the non-AP STA includes information associated with at least one of:
a link ID, when the non-AP STA has established multiple links with the first AP, of a link or band of channels in which the non-AP STA requests the first AP to declare the channel for off-channel P2P communication,
a traffic requirement of the non-AP STA for P2P communication between the non-AP STA and other non-AP STAs,
characteristics of a P2P group that the non-AP STA is a member of,
a time cadence of traffic or traffic arrival pattern of traffic that the non-AP STA intends the channel for off-channel P2P channel for, and
characteristics of other peer STAs of the non-AP STA.

18. The first AP of claim 17, wherein the processor is further configured to:
dedicate the channel for off-channel P2P communication among the non-AP STAs; and
reduce infrastructure operation on the dedicated channel; or
refrain from using the dedicated channel for infrastructure operation.

19. The first AP of claim 11, wherein the processor is further configured to:
receive, via the transceiver, a message from a non-AP station (STA) associated with the first AP, the message including information on a requirement of the STA regarding off-channel P2P communication of the STA.

20. The first AP of claim 11, wherein the processor is further configured to:
determine a first set of channels for off-channel P2P communication, the first set of channels comprising one or more channels;
determine a time duration, corresponding to each channel of the first set of channels, during which the first AP will reduce infrastructure operation on the first set of channels; and
transmit, via the transceiver, the first set of channels and the time duration to the second AP.
